(19) United States
(12) Patent Application Publication
(10) Pub. No.: US 2006/0192406 A1
(43) Pub. Date: Aug. 31, 2006

(54) Retractable roof for a truck topper

(76) Inventor: Mitch Seiberling, Pleasant Hill, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/065,811

(22) Filed: Feb. 25, 2005

(51) Int. Cl. B60J 11/00

(52) U.S. Cl. 296/98

(57) ABSTRACT

A truck topper having a pair of sidewalls in parallel spaced relation and adapted to be mounted to the bed of a truck at one end and having grooves at an opposite end. The grooves receive a retractable roof such that when attached to a retraction assembly the roof will retract to open the top of the truck topper.

### BACKGROUND OF THE INVENTION

The present invention relates to a truck topper and more specifically to a truck topper having a retractable roof.

Truck toppers are devices which are adapted for placement on the bed of a standard pickup truck to thereby enclose the pickup truck bed. A standard truck topper has a front end, a rear end, a roof, and side walls. Usually a door is placed in the rear end of the truck topper to allow access to the contents of the pickup bed.

A problem in the art exists in that when items that are taller than the truck topper are placed into the bed of a pickup truck, the truck topper must be removed which is time consuming and physically difficult for one person. To solve this problem, devices having complicated canopy systems with retractable canopies allow the canopy to be retracted for the loading of an item in the truck that is taller than the canopy.

For example, one device has an arcuate bow that supports a canopy that can be moved from an open position to a closed position of the container of a truck. A disadvantage is that the cover moves as a single unit eliminating the structural support of the sidewalls for securing a load during transport.

Accordingly, a need exists in the art for a topper for a truck having a roof portion that is independently retractable from the side portions.

Therefore, it is a principle object of the present invention to provide a truck topper that has a retractable roof to allow for easy storage and transport of items taller than the sides of the truck topper.

Yet another object of the present invention is to provide a truck topper having a roof portion that is retracted by a retraction assembly that is manual or automatic.

Another object of the invention is to provide a truck topper that will accommodate tall loads and provide structural support during transport.

Yet another object of the present invention is to provide a truck topper that has a retractable roof that is resilient to the elements.

These and other objects, features, or advantages of the present invention will become apparent from the specification and claims.

### BRIEF SUMMARY OF THE INVENTION

A truck topper that has a pair of side walls that are in parallel spaced relation mounted to the bed of a truck. One edge of the side wall is adapted to be attached to the bed of the truck and the opposite edge has grooves on its interior wall for receiving a roof portion. The roof portion is slidable within the grooves to be moved from closed to open positions. A retraction assembly is attached to the roof portion to facilitate movement of the roof portion between open and closed positions.

### BRIEF DESCRIPTION OF THE DRAWINGS

FIG. 1 is a perspective view of the truck topper;

FIG. 2 is a perspective view of an alternative embodiment of a truck topper;

FIG. 3 is a top view of a truck topper;

FIG. 4 is a side view of a truck topper; and

FIG. 5 is a perspective view of a truck topper.

### DESCRIPTION OF THE PREFERRED EMBODIMENTS

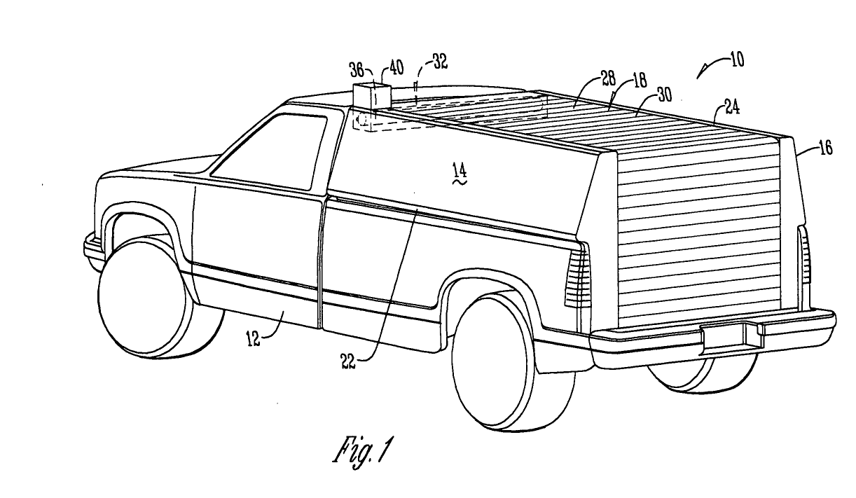

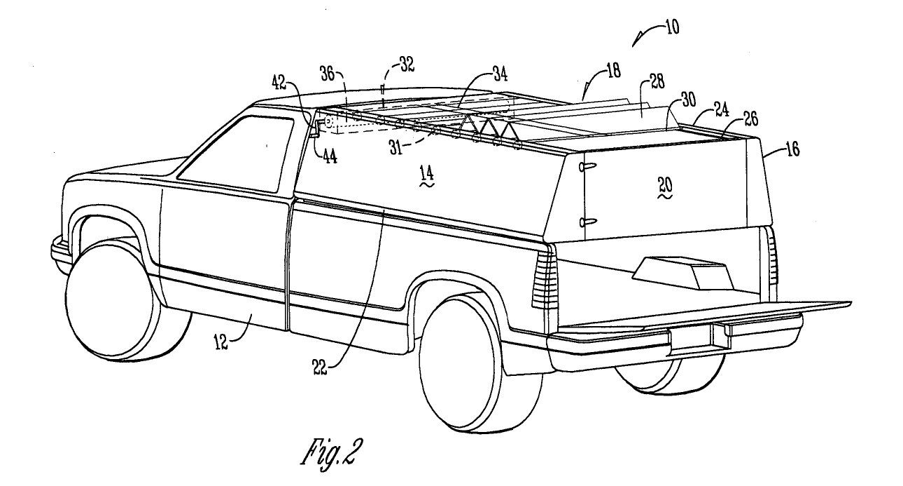

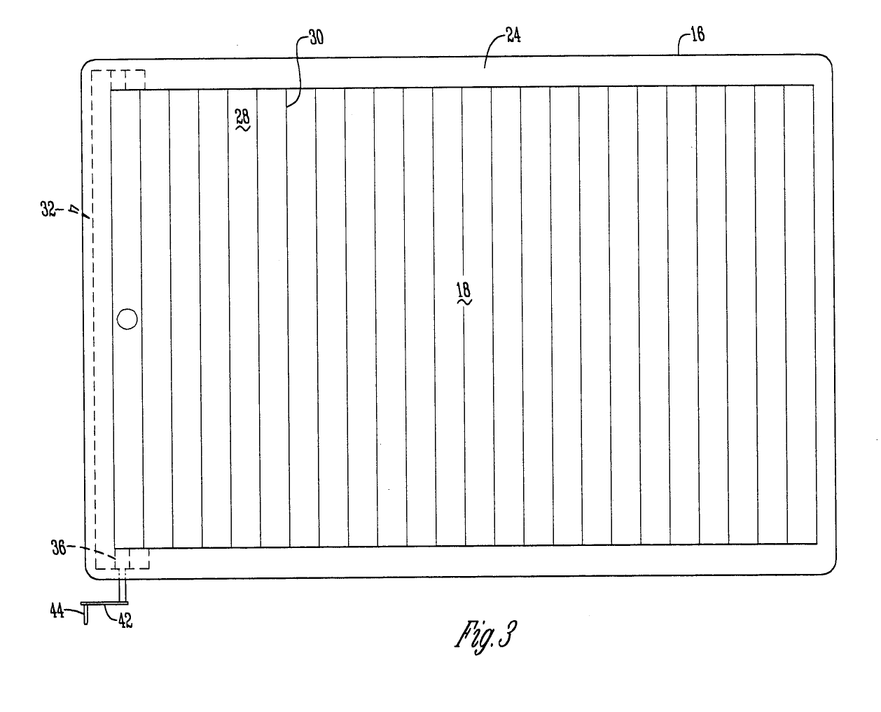

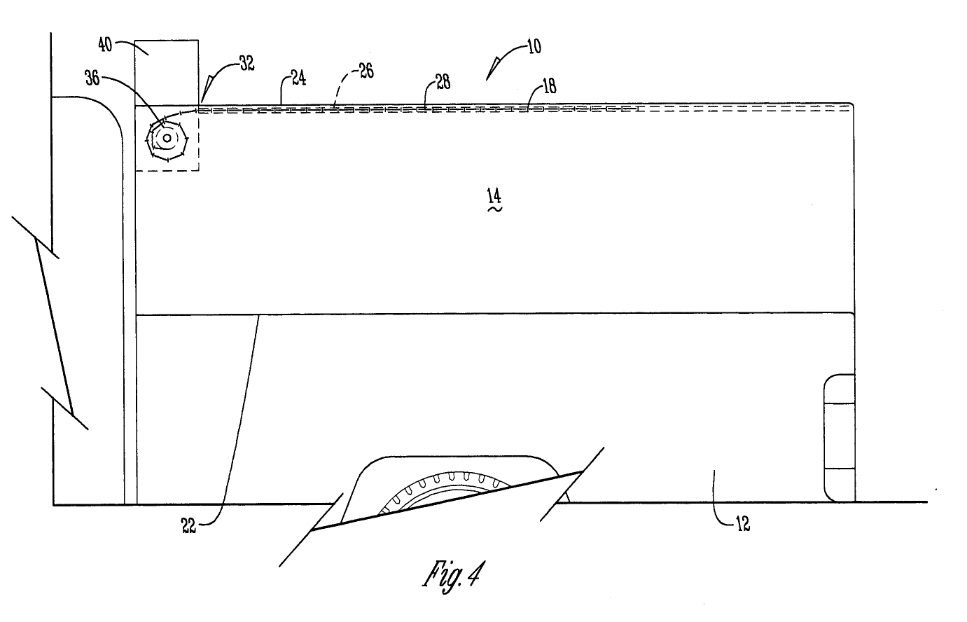

FIGS. 1-4 show a truck topper 10 that is mounted onto the back of a pickup truck 12 and has side walls 14 and 16, and a roof portion 18 that preferably extends to the tailgate of the truck 12. Optionally a door 20 (FIG. 2) can be hingedly attached to a side wall 14 or 16 to provide an opening in the topper 10 above the tailgate of the truck 12. In a preferred embodiment the side walls 14, 16 have a bottom edge 22 that is adapted to be attached to the bed of the truck 12 and has an opposite edge 24 with a groove 26 on the interior portion of the side wall 14 or 16. In one example, the roof portion 18 is comprised of a plurality of slats 28 and a plurality of lateral shafts 30 that are positioned to allow the roof to fold like an accordion as best shown in FIG. 2. Attached to the shafts 30 are a plurality of wheels or rollers 31 that are received within the groove 26 of sidewalls 14 and 16. The rollers 31 are moveable within the grooves 26 in order to allow the roof portion 18 to move in a longitudinal direction toward the cab of the pickup 12 and vice versa. Alternatively, other types of roof portions can be used such as resilient plastic or rubber.

A retractor assembly 32 is used to move the roof portion 18 in a longitudinal direction. In one example, as shown in FIG. 2, the retraction assembly 32 has at least one cable 34 that is attached to the roof portion 18 at the end adjacent the tailgate of the truck 12 to pull the roof 18 in a longitudinal direction toward the cab of the truck. The cable 34 is attached to a cylinder 36 that rotates such that the cable will wrap around the cylinder and pull the roof portion 18 toward the cylinder 36. The cylinder 36 is rotated by a crank shaft 42 which is operated either by a power means such as a motor 40, or manually by a handle 44.

In another example, the cylinder 36 is attached to the roof portion 18 at the end adjacent the retractor assembly 32 either directly or by at least one cable 34. As the cylinder is rotated, the roof portion 18 is pulled toward the retractor assembly and the roof portion wraps around cylinder 36. In this manner, the roof portion 18 is moved to an open position allowing access to the bed of the truck 12.

To move the roof portion 18 to a closed position one would pull on the end of the roof portion 18 opposite the retractor assembly in a direction toward the tailgate of the truck exerting sufficient manual force to rotate the cylinder 36 in the opposite direction releasing either the roof portion 18 or the cable 34 from the shaft 36. The power source also could activate to rotate the cylinder in the opposite direction to release and close the roof portion 18.

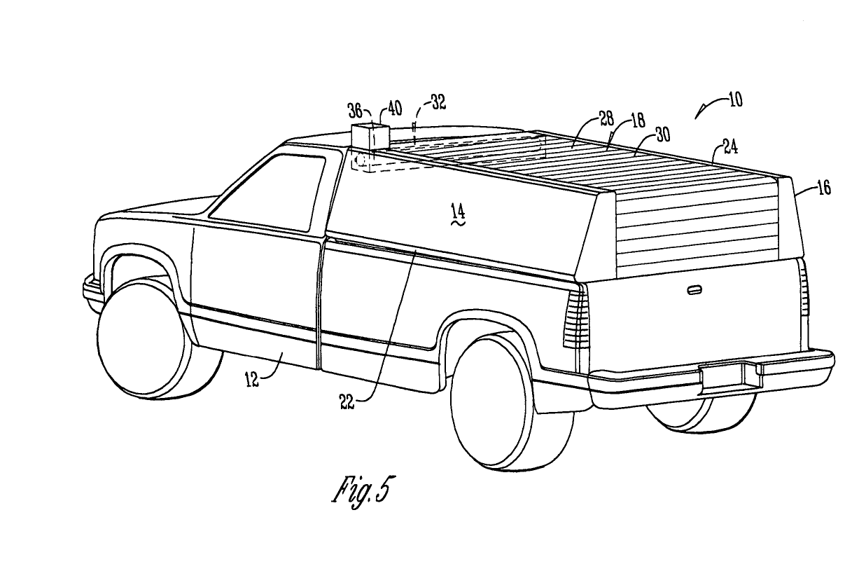

One skilled in the art will appreciate that the truck topper 10 may be made of a fiberglass material or any other resilient material that improves the integrity of the truck topper and also ensures maximum security. Additionally, one skilled in the art will understand that the roof portion 18 can be made of an aluminum material or any rain and weather resistant material that also allows for maximum protection against the elements and others. Also, one skilled in the art will appreciate that by having the door 20 hinged to one of the side walls 14 or 16 that the door 20 of the topper 10 may be opened from the side allowing the roof portion 18 to extend down the sidewalls 14 and 16 of the truck 12 because the door 20 is not attached to the roof portion 18. Also, as shown in FIG. 5, the roof portion may extend down the rearward end of the topper to engage the tailgate when the tailgate is in a closed position. Thus, an improved truck topper with a retractable roof is provided and at least the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A truck topper comprising:
a pair of fixed sidewalls in parallel spaced relation attached to a truck;
a roof portion movably received by the sidewalls;
a retraction assembly operatively connected to the roof portion; and
a door hingedly connected to one of the sidewalls.

2. The truck topper of claim 1 wherein the retraction assembly is actuated by a motor.

3. The truck topper of claim 1 wherein the retraction assembly has a crank shaft.

4. The truck topper of claim 1 wherein the roof portion comprises a plurality of slats and shafts.

5. (canceled)

6. The truck topper of claim 1 wherein the sidewalls are made of fiberglass material.

7. The truck topper of claim 1 wherein the roof portion is made of an aluminum material.

8. The truck topper of claim 1 wherein the retraction assembly comprises at least one retraction cable attached to the roof portion; a cylinder rotatably connected to the cable; and a power means operatively connected to the cylinder.

9. The truck topper of claim 8 wherein the retraction assembly has a plurality of cables.

10. The truck topper of claim 1 wherein grooves are formed within the inner sides of the sidewalls.

11. The truck topper of claim 10 wherein rollers are rotatably attached to the roof portion and within the grooves of the sidewalls.

12. The truck topper of claim 1 wherein the retraction assembly comprises a cylinder attached to the roof portion; and a power means operatively connected to the cylinder.

13. A truck topper comprising:
a pair of fixed sidewalls in parallel spaced relation attached to a truck;
a roof portion movably received by the sidewalls such that the roof portion may extend down the rearward end of the topper and is adapted to engage a tailgate when the tailgate is in a closed position;
a retraction assembly operatively connected to the roof portion.

14. The truck topper comprising:
a pair of fixed sidewalls in parallel spaced relation attached to a truck;
a roof portion movably received by the sidewalls;
a retraction assembly operatively connected to the roof portion;
said retraction assembly having a cylinder attached to the roof portion such that as the cylinder is rotated the roof portion wraps around the cylinder.

15. The truck topper of claim 1 wherein the sidewalls have a bottom edge that is adapted to be attached to the bed of a truck.

16. The truck topper of claim 1 wherein the truck topper is mountable to a bed of a pickup truck.

17. The truck topper of claim 13 wherein the roof portion may extend down the rearward end of the topper and is adapted to engage a bed of a pickup truck.
